(19) United States
(12) Patent Application Publication
(10) Pub. No.: US 2016/0117664 A1
(43) Pub. Date: Apr. 28, 2016

(54) SYSTEMS AND METHODS FOR ASSOCIATING OBJECT MOVEMENT WITH A PREDETERMINED COMMAND FOR APPLICATION IN A TRANSACTION

(71) Applicant: Toshiba Global Commerce Solutions Holdings Corporation, Tokyo (JP)

(72) Inventors: Dean F. Herring, Youngsville, NC (US); Adrian X. Rodriguez, Durham, NC (US); Brad M. Johnson, Raleigh, NC (US); Jeffrey J. Smith, Raleigh, NC (US)

(21) Appl. No.: 14/526,381

(22) Filed: Oct. 28, 2014

(51) Int. Cl. G06Q 20/20; G06Q 20/32

(52) U.S. Cl. CPC G06Q 20/208; G06Q 20/3278

(57) ABSTRACT

Systems and methods for associating object movement with a predetermined command for application in a transaction are disclosed. According to an aspect, a method includes associating an object with a transaction. The method also includes determining whether the object moves in accordance with a predetermined movement. Further, the method includes applying a predetermined command in the transaction in association with the object in response to determining that the object moves in accordance with the predetermined movement.

### FIELD

Embodiments described herein relate to transaction commands. More particularly, embodiments described herein relate to systems and methods for associating object movement with a predetermined command for application in a transaction.

### BACKGROUND

In retail environments, point-of-sale (POS) equipment is often utilized for managing accounting, purchase transactions, and other processes within the retail environment. For example, POS equipment may be used for scanning items, calculating an amount owed by a customer, providing payment options to the customer, accepting customer payment, and issuing a receipt for the purchase transaction. Recently, self-checkout POS equipment has become popular among retailers and customers, and present an alternative to traditional cashier-attended checkout. By use of self-checkout POS equipment, a customer may scan items and conduct a purchase transaction without assistance of a cashier.

Self-checkout POS equipment and traditional cashier-attended POS equipment are designed to make purchase transactions more convenient and less time consuming. For example, often POS equipment includes touchscreen displays so that the entry of commands by customers and cashiers is more convenient. In addition, POS equipment is often provided with an electronic signature capture pad to enable customers to use a stylus to sign for purchase transactions rather than signing a paper receipt. Although many such advances have been made, there is a continuing need for improved systems and methods for inputting customer and cashier commands into POS equipment.

### BRIEF DESCRIPTION OF THE DRAWINGS

The foregoing summary, as well as the following detailed description of various embodiments, is better understood when read in conjunction with the drawings provided herein. For the purposes of illustration, there is shown in the drawings exemplary embodiments; however, the presently disclosed subject matter is not limited to the specific methods and instrumentalities disclosed.

FIG. 1 is a block diagram of a system for associating object movement with a predetermined command for application in a transaction in accordance with embodiments of the present disclosure;

FIG. 2 is a flow chart of an example method for associating object movement with a predetermined command for application in a transaction in accordance with embodiments of the present disclosure;

FIG. 3 is a perspective view of a product being moved within a predetermined space for applying a predetermined command in a purchase transaction in accordance with embodiments of the present disclosure;

FIG. 4 is a flow chart of another example method for associating object movement with a predetermined command for application in a transaction in accordance with embodiments of the present disclosure; and

FIG. 5 depicts a display screen displaying a graphic representative of a product in a display space representative of a predetermined space in accordance with embodiments of the present disclosure.

### DETAILED DESCRIPTION

The presently disclosed subject matter is described with specificity to meet statutory requirements. However, the description itself is not intended to limit the scope of this patent. Rather, it has been contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

As referred to herein, the term “computing device” should be broadly construed. It can include any type of device including hardware, software, firmware, the like, and combinations thereof. A computing device may include one or more processors and memory or other suitable non-transitory, computer readable storage medium having computer readable program code for implementing methods in accordance with embodiments of the present disclosure. A computing device may be, for example, a server or other computer located within a retail environment and communicatively connected to other computing devices (e.g., point-of-sale (POS) equipment or computers) for managing accounting, purchase transactions, and other processes within the retail environment. In another example, a computing device may be a mobile computing device such as, for example, but not limited to, a smart phone, a cell phone, a pager, a personal digital assistant (PDA), a mobile computer with a smart phone client, or the like. A computing device can also include any type of conventional computer, for example, a laptop computer or a tablet computer. A typical mobile computing device is a wireless data access-enabled device (e.g., an iPHONE® smart phone, a BLACKBERRY® smart phone, a NEXUS ONE™ smart phone, an iPAD® device, or the like) that is capable of sending and receiving data in a wireless manner using protocols like the Internet Protocol, or IP, and the wireless application protocol, or WAP. This allows users to access information via wireless devices, such as smart phones, mobile phones, pagers, two-way radios, communicators, and the like. Wireless data access is supported by many wireless networks, including, but not limited to, CDPD, CDMA, GSM, PDC, PHS, TDMA, FLEX, ReFLEX, iDEN, TETRA, DECT, DataTAC, Mobitex, EDGE and other 2G, 3G, 4G and LTE technologies, and it operates with many handheld device operating systems, such as PalmOS, EPOC, Windows CE, FLEXOS, OS/9, JavaOS, iOS and Android. Typically, these devices use graphical displays and can access the Internet (or other communications network) on so-called mini- or micro-browsers, which are web browsers with small file sizes that can accommodate the reduced memory constraints of wireless networks. In a representative embodiment, the mobile device is a cellular telephone or smart phone that operates over GPRS (General Packet Radio Services), which is a data technology for GSM networks. In addition to a conventional voice communication, a given mobile device can communicate with another such device via many different types of message transfer techniques, including SMS (short message service), enhanced SMS (EMS), multi-media message (MMS), email WAP, paging, or other known or later-developed wireless data formats. Although many of the examples provided herein are implemented on smart phone, the examples may similarly be implemented on any suitable computing device, such as a computer.

As referred to herein, the term “user interface” is generally a system by which users interact with a computing device. A user interface can include an input for allowing users to manipulate a computing device, and can include an output for allowing the computing device to present information and/or data, indicate the effects of the user's manipulation, etc. An example of a user interface on a computing device includes a graphical user interface (GUI) that allows users to interact with programs or applications in more ways than typing. A GUI typically can offer display objects, and visual indicators, as opposed to text-based interfaces, typed command labels or text navigation to represent information and actions available to a user. For example, a user interface can be a display window or display object, which is selectable by a user of a computing device for interaction. The display object can be displayed on a display screen of a computing device and can be selected by and interacted with by a user using the user interface. In an example, the display of the computing device can be a touch screen, which can display the display icon. The user can depress the area of the display screen where the display icon is displayed for selecting the display icon. In another example, the user can use any other suitable user interface of a computing device, such as a keypad, to select the display icon or display object. For example, the user can use a track ball or arrow keys for moving a cursor to highlight and select the display object.

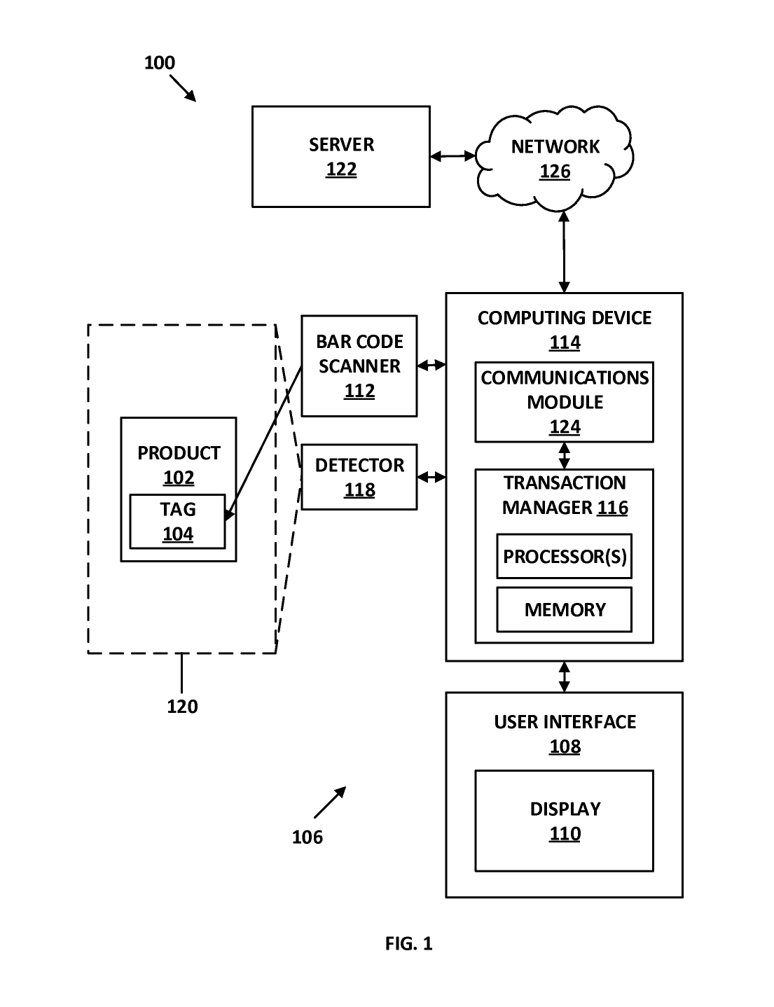

The presently disclosed subject matter is now described in more detail. For example, FIG. 1 illustrates a block diagram of a system 100 for associating object movement with a predetermined command for application in a transaction in accordance with embodiments of the present disclosure. Referring to FIG. 1, the system 100 may be implemented in whole or in part in any suitable environment for conducting purchase transactions. For example, the system 100 may be implemented in a retail store having a variety of products or items for purchase. A respective product or item 102 for purchase may have an item tag 104 that contains identifying information about a particular product item. The item tag 104 may be physically attached to the item or packaging or may be displayed in closely-spaced relation to the particular product item. The item tag 104 may contain, for example, identifying information or indicia such as, but not limited to, a bar code such as a SKU number or UPC number, a QR code, a store item number, radio frequency identification (RFID) tag, and the like.

The product 102 may be carried or otherwise transported to POS equipment 106 by a customer in a retail environment for purchase of the product 102. In this example, the POS equipment 106 is self-checkout POS equipment, although it should be understood that the components and functionality may similarly be applied to cashier-attended POS equipment. The customer may also carry one or more other products to the POS equipment 106 At the POS equipment 106, the customer may initiate a purchase transaction by interaction with a user interface 108 of the POS equipment 106. For example, the customer may touch a button of the user interface 108 to initiate the purchase transaction. In an example, the user interface 108 may include a touchscreen display 110 having a screen that can display a “START” button can be touched by the customer for initiating the purchase transaction.

Subsequent to initiating the purchase transaction, a customer may begin scanning or otherwise identifying one or more products for purchase. For example, the POS equipment 106 may include a bar code scanner 112 or other suitable scanner configured to scan the item tag 104 affixed to the product 102. In this way, the bar code scanner 112 can suitably determine an identifier of the product 102. Subsequently, the bar code scanner 112 may communicate, to a computing device 114, an electrical signal representative of the identifier of the product 102.

The computing device 114 may include a transaction manager 116 configured to initiate a purchase transaction for the product 102 in response to the scan of the product 102. The transaction manager 116 may include hardware, software, firmware, or combinations thereof. For example, the transaction manager 116 may include one or more processors and memory. In response to the scan of the product 102, the transaction manager 116 may control the display 110 to display information about the product 102 to indicate that the product has been successfully scanned. For example, the display 110 may be controlled to display a name of the product, pricing information, quantity, and other suitable information. Further, the transaction manager 116 may add the product 102 to the purchase transaction. The customer may subsequently scan other products, which may be similarly processed by the transaction manager 116 and the information about the product(s) displayed.

The POS equipment 106 may include a detector 118 operably connected to the computing device 114. The detector 118 may be configured to determine movement of the product 102, and to apply a predetermined command in the purchase transaction based on the determined movement. Movement of the product 102 or another product may be detected or determined by any suitable technique. For example, a scanner may detect the presence of an object within it range to thereby detect whether it moves within or away from its range. In another example, any suitable wireless emitter or multiple emitters may detect or determine movement of the product. For example, the wireless emitters may generate communication signals for triangulating a wireless product tag via any suitable technique. The product tag may be detected within the electromagnetic field of the emitters so that the location in time of the tag can be extrapolated as the tag is moved.

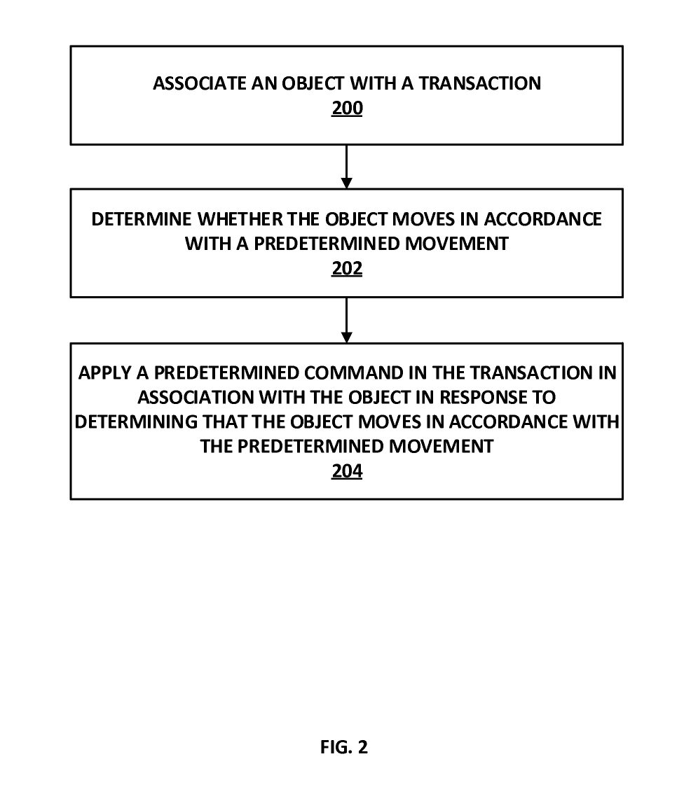

As an example, FIG. 2 illustrates a flow chart of an example method for associating object movement with a predetermined command for application in a transaction in accordance with embodiments of the present disclosure. The method of FIG. 2 is described by example as being implemented by the system 100 shown in FIG. 1, although it should be appreciated that the method may alternatively be implemented by any other suitable system or suitably-configured computing device.

Referring to FIG. 2, the method includes associating 200 an object with a transaction. As an example, a customer in a retail environment may carry the product 102 to the POS equipment 106 for purchase of the product 102. The customer may subsequently initiate a purchase transaction by suitably interacting with the user interface 108. Next, the customer may position the product 102 such that the tag 104 can be scanned by the bar code scanner 112. The identifier for the product 102 obtained by the bar code scanner 112 may subsequently be communicated to the transaction manager 116 for processing. The transaction manager 116 may associate the identifier with the initiated purchase transaction.

The method of FIG. 2 includes determining 202 whether the object moves in accordance with a predetermined movement. Continuing the aforementioned example, the detector 118 may be configured to detect movement of the product 102 within a predetermined space 120 (generally represented in FIG. 1 by a rectangle shape with broken lines). It is noted that although the predetermined space 120 is represented by a rectangle shape in FIG. 1, it should be appreciated that the shape can be in suitable shape in two-dimensions or three-dimensions. Also, the predetermined space 120 can be any suitable size. The predetermined space 120 is intended to represent a space within which the detector 118 can detect movement of the product 102.

The detector 118 may be any suitable device configured to detect movement of the product 102. The detector 118 may be oriented such that it can detect movement of the product 102 with the predetermined space 120, which may be in close proximity to a position of the customer when she or he interacts with the user interface 108. The customer standing near the predetermined space 120 may then move the product 102 to effect one or more predetermined commands for application to the purchase transaction. The detector 118 may detect movement of the product 102 and communicate to the transaction manager 116 information about the movement of the product 102.

Example predetermined commands for application to a purchase transaction can be any suitable command that may be applied to the transaction. For example, the predetermined command may relate to the product being moved and/or another product associated with the current purchase transaction. The other product may be another product that the user intends to purchase in the same purchase transaction. In another example, the predetermined command may be a command that is not associated with any particular product in the transaction, but rather the transaction more generally. Example predetermined commands include, but are not limited to: removing the product (or object) from the purchase transaction; adding another of the product (or object) to the transaction (e.g., multiple numbers of the same product may be purchased, so this command can be used to enter the quantity of products); and requesting information about the product (or object).

In accordance with embodiments, movement of the object may be detected in any suitable manner. For example, the detector 118 may be a near field communication (NFC) device configured to communicate with the product 102 or a suitably configured tag 104 for determining a strength of an NFC signal associated with the product 102. Other example communication systems include, but are not limited to, radio frequency identification (RFID) and BLUETOOTH®. The detector 114 may communicate to the transaction manager 116 an indication of the strength of the communication signal. The transaction manager 116 may determine whether the signal strength is increasing or decreasing. Based on whether the signal strength is increasing or decreasing, the transaction manager 116 may determine whether the product 102 is being moved towards or away from the detector 118. If the signal strength increases, the transaction manager 116 may determine that the product 102 is being moved towards the detector 118. If the signal strength decreases, the transaction manager 116 may determine that the product 102 is being away from the detector 118.

In another example of detecting or determining movement, multiple detector 118 may be utilized to determine a more particular direction of product movement. For example, two or more detectors can be used to determine whether the product is moving closer to one of the detectors as compared to another. This may be determined based on signal strength as described herein. In this way, a determination may be made about whether the product is moving in a rightward or leftward direction.

In another example of detecting object movement, the detector 118 may include an image capture device configured to capture one or more images of the product 102 within the predetermined space 120. For example, the image capture device may be a still camera or a video camera configured to capture digital images. The detector 118 may communicate to the transaction manager 116 the image(s) and/or related data. The transaction manager 116 may determine movement of the product 102 based on the image(s) and/or related data. Based on the image(s) and/or related data, the transaction manager 116 may determine a direction of movement of the product 102.

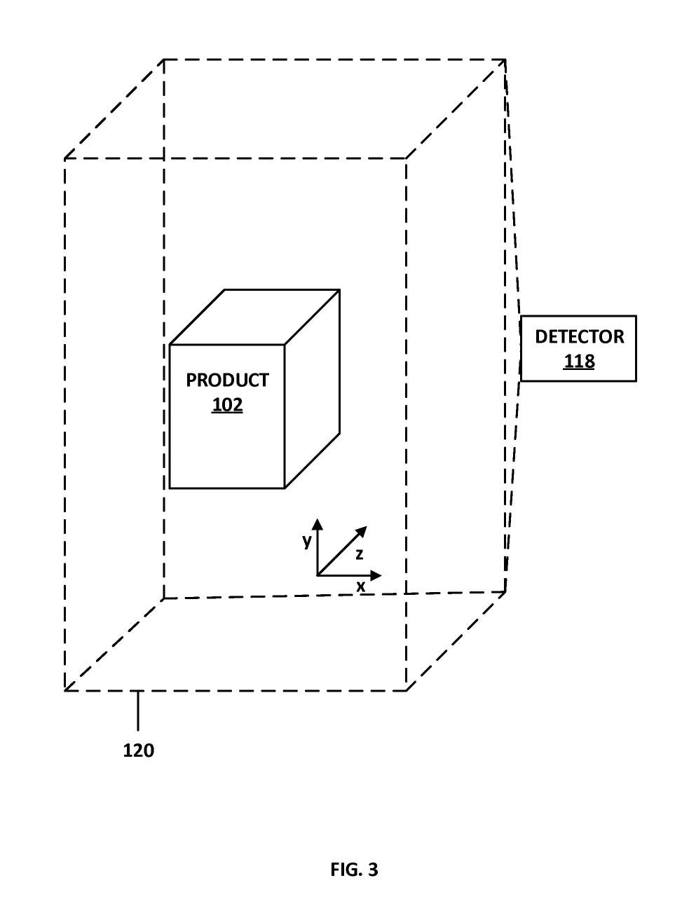

A predetermined movement may be any suitable movement of an object that can be distinguished from other movements of the object. For example, FIG. 3 illustrates a perspective view of a product 102 being moved within a predetermined space 120 for applying a predetermined command in a purchase transaction in accordance with embodiments of the present disclosure. Referring now to FIG. 3, the detector 118 may be configured and positioned to detect movement of the product 102 within the predetermined space 120. It is noted that the predetermined space 120 is depicted as being a three dimensional rectangle (or right prism) for ease of illustration, but it should be understood that the determined space 120 can be any shape of any size. Also, the predetermined space 120 is depicted as being in a three dimensional Cartesian coordinate system having axes x, y, and z for ease in describing exemplary movements of the product 102 within the predetermined space 120. During operation, the detector 118 may be configured to detect movement of the product 102 in the positive direction along the x axis. This movement may be determined to be associated with adding the product 102 to a purchase transaction. Further movement in the same direction may be associated with adding another of the same product 102 to the purchase transaction. In contrast, movement of the product 102 in the negative direction along the x axis may be associated with subtracting the product 102 from the purchase transaction. Movement of the product 102 along the y axis or z axis may be associated other commands. For example, movement of the product 102 along the y axis may be associated with a request for additional information about the product 102. For example, the additional information about the product 102 may contain a production area, nutrition facts, recommendations of related products, available vouchers, etc. Such movements may be recognized by the detector 118 and data or information about such movements may be communicated to the transaction manager 116 (shown in FIG. 1) for processing as disclosed herein.

Now returning to FIG. 2, the method includes applying 204 a predetermined command in the transaction in association with the object in response to determining that the object moves in accordance with the predetermined movement. Continuing the aforementioned example, the transaction manager 116 may apply the predetermined command in the transaction in association with the object in response to determining that the object moves in accordance with the predetermined movement. For example, in response to movement for removing the product from the purchase transaction, the transaction manager 116 may subtract the identified product 102 from the purchase transaction associated with the product 102. In another example, in response to a request for additional information about the product, the transaction manager 116 may obtain the requested additional information about the product and subsequently present the information to the customer (e.g., control the display 110 to display the information).

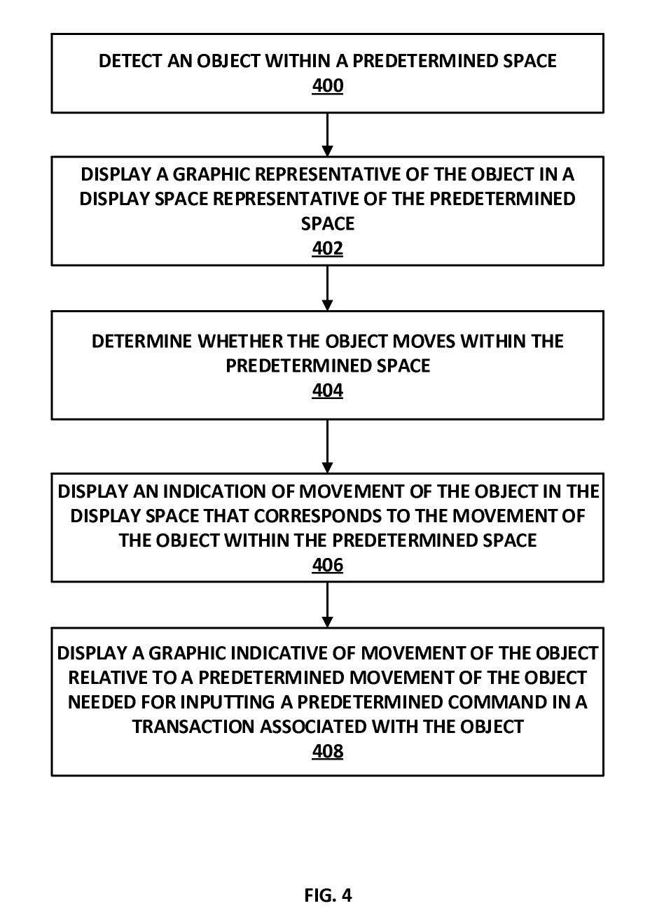

In accordance with embodiments, systems disclosed herein may display graphics to indicate movement of an object for assisting a customer to move the object in a predetermined movement for effecting entry or input of a desired command. In this way, the system can provide feedback to a customer about movement of the object within a predetermined space within range of a detector. For example, FIG. 4 illustrates a flow chart of another example method for associating object movement with a predetermined command for application in a transaction in accordance with embodiments of the present disclosure. The method of FIG. 4 is described by example as being implemented by the system 100 shown in FIGS. 1 and 3, although it should be appreciated that the method may alternatively be implemented by any other suitable system or suitably-configured computing device.

Referring to FIG. 4, the method includes detecting 400 an object within a predetermined space. For example, the detector 118 shown in FIGS. 1 and 3 may detect the product 102 within the predetermined space 120. Subsequently, the detector 118 may communicate to the transaction manager 116 information or data indicating detection of the product 102 in the predetermined space 120. The communicated information may indicate a position, orientation, and/or direction of movement of the product 102 within the predetermined space 120. In another example, the bar code scanner 112 may detect the product 102 by scanning and identifying the object based on the scan.

The method of FIG. 4 includes displaying 402 a graphic representative of the object in a display space representative of the predetermined space. Continuing the aforementioned example, the transaction manager 116 may control the display 110 to display a graphic representative of the product 102 in a display space representative of the predetermined space. For example, the display 110 may display a two dimensional representation of the display space. In this example, the display space may be outlined by one or more lines (e.g., a rectangular shape), and the interior area of the lines represents the display space. A graphical icon or other representation of a product may be placed within the interior area in a position corresponding to the position of the product in the actual predetermined space. For example, the product may be positioned in a top right portion of the predetermined space, and this position would be represented by the graphical icon of the product being positioned in the top right portion of the interior area.

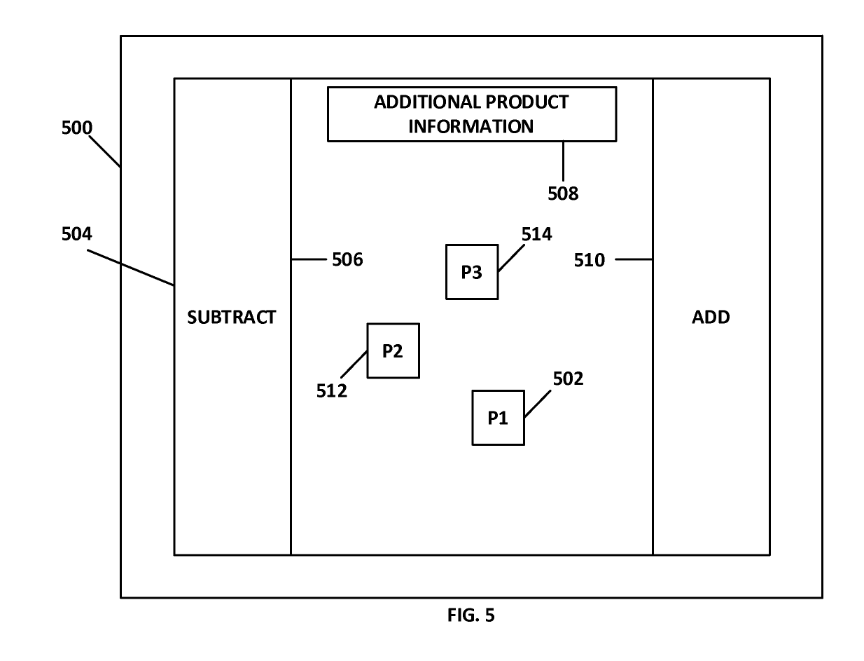

As another example of displaying a graphic representative of an object, FIG. 5 illustrates a display screen 500 displaying a graphic representative of a product in a display space representative of a predetermined space in accordance with embodiments of the present disclosure. In this example, reference is made to the product 102 positioned within the predetermined space 120 as shown in FIG. 3, although this should not be considered limiting as the display screen 500 may suitably display any number of products detected by any suitable system. Now referring to FIG. 5, the product 102 shown in FIG. 3 is represented by graphical icon 502. The large rectangle 504 represents the predetermined space 120 shown in FIG. 3. Movement of product 102 along the x and y axes shown in FIG. 3 may be represented by movement of graphical icon 502 in corresponding directions of the x and y axes of the display screen 500. The display may be controlled to move the graphical icon 502 in corresponding directions. Thus, to a customer moving the product 102 in the predetermined space 120 shown in FIG. 3, it will appear that the movement corresponds directly with movement of the graphical icon 502 within the rectangle 500.

With returning reference to FIG. 4, the method includes determining 404 whether the object moves within the predetermined space. Continuing the aforementioned example, the transaction manager 116 determines whether the product 102 moves within the predetermined display space 120. The transaction manager 116 may determine the movement based on data received from the detector 118 as disclosed herein.

The method of FIG. 4 includes displaying 406 an indication of movement of the object in the display space that corresponds to the movement of the object within the predetermined space. Continuing the aforementioned example, the transaction manager 116 may control the display 110 to display an indication of movement of the product 102 in a display space that corresponds to the movement of the product 102 within the predetermined space 120. An example of such movement is described as set forth above with respect to FIG. 5. In this example, the graphical icon 502 moves in the x and y coordinate space of the display screen 500 in a way that corresponds to the x and y axes of the predetermined space 120 shown in FIG. 3.

The method of FIG. 4 includes displaying 408 a graphic indicative of movement of the object relative to a predetermined movement of the object needed for inputting a predetermined command in a transaction associated with the object. Continuing the aforementioned example, the transaction manager 116 may control the display 110 to display a graphic indicative of movement of the product 102 relative to a predetermined movement of the product 102 needed for inputting a predetermined command in a purchase transaction associated with the product 102. Further as an example, the graphical icon 502 shown in FIG. 5 can be moved based on the movement of the product 102 shown in FIG. 3 such that the position of the graphical icon 502 is within one of graphical icons 506, 508, and 510. In response to the graphical icon 502 being positioned within graphical icon (or display icon) 506, the product 102 may be removed from the purchase transaction. In response to the graphical icon 502 being positioned within graphical icon 510, the product 102 may be added to the purchase transaction. In response to the graphical icon 502 being positioned within graphical icon 508, additional information about the product 102 may be displayed in the display screen 500.

In accordance with embodiments, multiple display or graphic icons can be displayed that are associated with different products and can be controlled separately for entering commands in a purchase transaction. A graphic icon may include any graphic displayed on a display screen representing an object in the physical word or for assisting a user to navigate a computing device. The graphic icon may be a small picture or symbol that serves as a quick, “intuitive” representation of a physical object (e.g., a product), software tool, function, or data file accessible on the computing device. Further, for example, a graphic icon may function to allow, in conjunction with computer windows, menus, and/or the like, to easily and intuitively navigate the computing device. Additional details and description of graphic icons for use in accordance with embodiments of the present subject matter are provided herein.

As an example of graphic icons, FIG. 5 shows the display of graphic icons 512 and 514 in addition to graphic icon 502. Graphic icons 512 and 514 are each representative of another product within a predetermined space. The products can be moved in the predetermined space for effecting movement of the graphic icons 512 and 514. In this way, the graphic icons 512 and 514 can be moved to be within graphic icons 506, 508, or 510 enter the corresponding predetermined command in association with the respective product. Although three graphic icons associated with products are shown in FIG. 5, it should be understood that any suitable number of products may be represented by graphic icons.

In accordance with embodiments, the systems and methods disclosed herein may be applied to any suitable system for entering a command into a computing device or system based on detected or determined movement of an object. For example, a system may be an inventory management system. In this example, an item being inventoried can be moved in a particular way for effecting a predetermined command. In another example, the systems and methods disclosed herein may be utilized in a restaurant setting for purchase of food items.

In accordance with embodiments, a system may detect whether a product is positioned is at a location difficult for detection. For example, the product may be out of range for detection. In response, the system may present on a user interface (e.g., display) information for correctly placing the product for detection.

In accordance with embodiments, a detector may be implemented in the form of a handheld device, such as a scanner. This implementation may be helpful for products that are heavy or otherwise difficult to carry and position with respect to a stationary detector.

In accordance with embodiments, POS equipment (e.g., POS equipment 106 shown in FIG. 1) may be operably configured with one or more other computing devices for operation in a retail environment. For example, the computing device 114 may be communicatively connected with a server 122 for use in storing and accessing data for implementing retail functions as will be understood to those of skill in the art. The computing device 114 may include a communications module 124 for communicating with the server 122 via a network 126.

The present subject matter may be a system, a method, and/or a computer program product. The computer program product may include a computer readable storage medium (or media) having computer readable program instructions thereon for causing a processor to carry out aspects of the present subject matter.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present subject matter may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present subject matter.

Aspects of the present subject matter are described herein with reference to flowchart illustrations and/or block diagrams of methods, apparatus (systems), and computer program products according to embodiments of the subject matter. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present subject matter. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While certain embodiments have been described, these embodiments have been presented by way of example only, and are not intended to limit the scope of the present disclosure. Indeed, the novel methods, devices, and systems described herein may be embodied in a variety of other forms. Furthermore, various omissions, substitutions, and changes in the form of the methods, devices, and systems described herein may be made without departing from the spirit of the present disclosure. The accompanying claims and their equivalents are intended to cover such forms or modifications as would fall within the scope and spirit of the present disclosure.

What is claimed:

1. A method comprising:
associating an object with a transaction;
using a detector to determine whether the object moves in accordance with a predetermined movement; and
in response to determining that the object moves in accordance with the predetermined movement, applying a predetermined command in the transaction in association with the object.

2. The method of claim 1, wherein associating an object with a transaction comprises:
using a scanner to scan the object;
identifying the object based on the scan of the object; and
adding the identified object to a purchase transaction.

3. The method of claim 2, wherein applying a predetermined command comprises removing the identified object from the purchase transaction.

4. The method of claim 2, wherein applying a predetermined command comprises adding another of the identified object to the purchase transaction.

5. The method of claim 1, wherein applying a predetermined command comprises requesting information about the identified object, and wherein the method further comprises presenting the information in response to the request.

6. The method of claim 1, wherein determining whether the object moves in accordance with a predetermined movement comprises:
determining strength of a communication signal associated with the object; and
determining a direction of movement of the object based on the determined strength of the communication signal.

7. The method of claim 6, wherein the communication signal is a near field communication (NFC) signal.

8. The method of claim 1, wherein determining whether the object moves in accordance with a predetermined movement comprises:
capturing video of the object; and
determining a direction of movement of the object based on the captured video.

9. A method comprising:
using a detector to detect an object within a predetermined space;
displaying a graphic representative of the object in a display space representative of the predetermined space;
determining whether the object moves within the predetermined space;
displaying an indication of movement of the object in the display space that corresponds to the movement of the object within the predetermined space; and
displaying a graphic indicative of movement of the object relative to a predetermined movement of the object needed for inputting a predetermined command in a transaction associated with the object.

10. The method of claim 9, wherein detecting an object comprises:
using a scanner to scan the object; and
identifying the object based on the scan of the object.

11. The method of claim 9, further comprising:
using the detector to determine whether the object moves in accordance with the predetermined movement; and
in response to determining that the object moves in accordance with the predetermined movement, applying the predetermined command in the transaction associated with the object.

12. The method of claim 11, wherein applying the predetermined command comprises removing the identified object from the purchase transaction.

13. The method of claim 11, wherein applying the predetermined command comprises adding another of the identified object to a purchase transaction.

14. The method of claim 11, wherein applying the predetermined command comprises requesting information about the identified object, and
wherein the method further comprises presenting the information in response to the request.

15. The method of claim 11, wherein determining whether the object moves in accordance with the predetermined movement comprises:
determining strength of a communication signal associated with the object; and
determining a direction of movement of the object based on the determined strength of the communication signal.

16. The method of claim 9, wherein the transaction is a purchase transaction, and
wherein the method further comprises:
displaying a plurality of display icons that are each associated with a different predetermined command in the purchase transaction;
displaying a display icon representative of the object; and
displaying movement of the display icon representative of the object in one or more directions corresponding to the determined object movement;
determining whether a current displayed position of the display icon representative of the object corresponds to one of the display icons associated with a predetermined command; and
in response to determining that the current displayed position of the display icon representative of the object corresponds to the one of the display icons associated with the predetermined command, applying the predetermined command in the purchase transaction.

17. A system comprising:
a detector configured to detect an object within a predetermined space;
a display; and
a computing device comprising at least one processor and memory configured to:
control the display to display a graphic representative of the object in a display space representative of the predetermined space;
determining whether the object moves within the predetermined space;
control the display to display an indication of movement of the object in the display space that corresponds to the movement of the object within the predetermined space; and
control the display to display a graphic indicative of movement of the object relative to a predetermined movement of the object needed for inputting a predetermined command in a transaction associated with the object.

18. The system of claim 17, wherein the computing device comprises point-of-sale equipment.

19. The system of claim 17, wherein the computing device is configured to:
determine whether the object moves in accordance with the predetermined movement; and
apply the predetermined command in the transaction associated with the object in response to determining that the object moves in accordance with the predetermined movement.

20. The system of claim 17, wherein the transaction is a purchase transaction, and
wherein the computing device is configured to:
control the display to display a plurality of display icons that are each associated with a different predetermined command in the purchase transaction;
control the display to display a display icon representative of the object; and
control the display to display movement of the display icon representative of the object in one or more directions corresponding to the determined object movement;
determine whether a current displayed position of the display icon representative of the object corresponds to one of the display icons associated with a predetermined command; and
apply the predetermined command in the purchase transaction in response to determining that the current displayed position of the display icon representative of the object corresponds to the one of the display icons associated with the predetermined command.
